(19) United States
(12) Patent Application Publication
(10) Pub. No.: US 2008/0075493 A1
(43) Pub. Date: Mar. 27, 2008

(54) Fuser assembly of electrophotographic printing device

(75) Inventor: Hsin Hong Chen, Jhunan Township (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/898,012

(22) Filed: Sep. 7, 2007

(30) Foreign Application Priority Data
Sep. 22, 2006 (TW) 095135050

(51) Int. Cl. G03G 15/20

(52) U.S. Cl. 399/69; 399/328

(57) ABSTRACT

A fuser assembly of an electrophotographic printing device for fusing toners on a medium. The fuser assembly includes a fuser roller, a driving mechanism, a fuser substrate and a heating source. The driving mechanism connected to the fuser roller drives the fuser roller to rotate and thus the medium is moved by the fuser roller. The fuser substrate, being stationary and disposed opposite the fuser roller, is in sliding contact with the medium. The heating source heats the fuser substrate such that the fuser substrate fuses the toners on the medium.

### BACKGROUND OF THE INVENTION

1. Field of Invention

The invention relates to a fuser assembly of an electrophotographic printing device, and more particularly to a fuser assembly of an electrophotographic printing device for fusing toners using a stationary fuser substrate.

2. Related Art

Conventional electrophotographic printing devices, such as laser printers and copiers or light emitting diode (LED) printers and copiers, fuse toners on sheets in a contact manner or non-contact manner. The non-contact fusing technology mainly includes the oven fusing technology and the heat-radiation fusing technology. The oven fusing technology needs the long warm-up time and occupies a very large space. The heat-radiation fusing technology has the short warm-up time, but its disadvantages such as the high cost, the high working temperature, the low safety, the incapability of keeping the constant temperature, and the large energy loss remain to be an issue to the manufacturers in the industry. The contact fusing technology mainly includes the high-temperature and high-pressure fusing technology, and one example will be illustrated as follows.

FIG. 1 is a partially schematic illustration showing a conventional laser printing device 100. Referring to FIG. 1, the conventional laser printing device 100 includes a photoconductor drum 101, a toner cartridge 102, a transfer unit 103, a laser assembly 104, a fuser roller 111 and a fuser 112. The photoconductor drum 101, the toner cartridge 102, the transfer unit 103, the fuser roller 111 and the fuser 112 are driven by a driving mechanism (not shown). The laser assembly 104 outputs a laser signal to the photoconductor drum 101 so that the photoconductor drum 101 is formed with portions (i.e., patterns) with different charges. The toners T in the toner cartridge 102 are attracted to the portions on the photoconductor drum 101. Then, the toners T on the photoconductor drum 101 are transferred to a print medium M by the transfer unit 103. The transfer unit 103 is mainly composed of a plurality of rollers 1031 and a conveyor belt 1032. Next, the print medium M is transported through the nip between the fuser roller 111 and the fuser 112 having a heating source 1121 so that the toners are fused in the high-temperature environment.

The contact fusing technology is frequently used at present, and has the advantages of the high security, the low temperature and the constant temperature, but has the drawbacks of the long warm-up time, the large energy loss, and the large occupied space.

### SUMMARY OF THE INVENTION

It is therefore an object of the invention to provide a fuser assembly of an electrophotographic printing device for fusing toners using a stationary fuser substrate to solve the above-mentioned problems.

To achieve the above-identified object, the invention provides a fuser assembly for an electrophotographic printing device. The fuser assembly includes a fuser roller, a driving mechanism, a fuser substrate and a heating source. The driving mechanism is connected to the fuser roller and drives the fuser roller to rotate, and thus a medium is moved by the fuser roller. The fuser substrate is stationary and disposed opposite the fuser roller, and is in sliding contact with the medium. The heating source heats the fuser substrate so that the fuser substrate fuses toners on the medium.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a partially schematic illustration showing a conventional laser printing device;

FIG. 2 is a partially schematic illustration showing an electrophotographic printing device according to a first embodiment of the invention;

FIG. 3 is a partially schematic illustration showing a fuser assembly according to a second embodiment of the invention; and

FIG. 4 is a partially schematic illustration showing a fuser assembly according to a third embodiment of the invention.

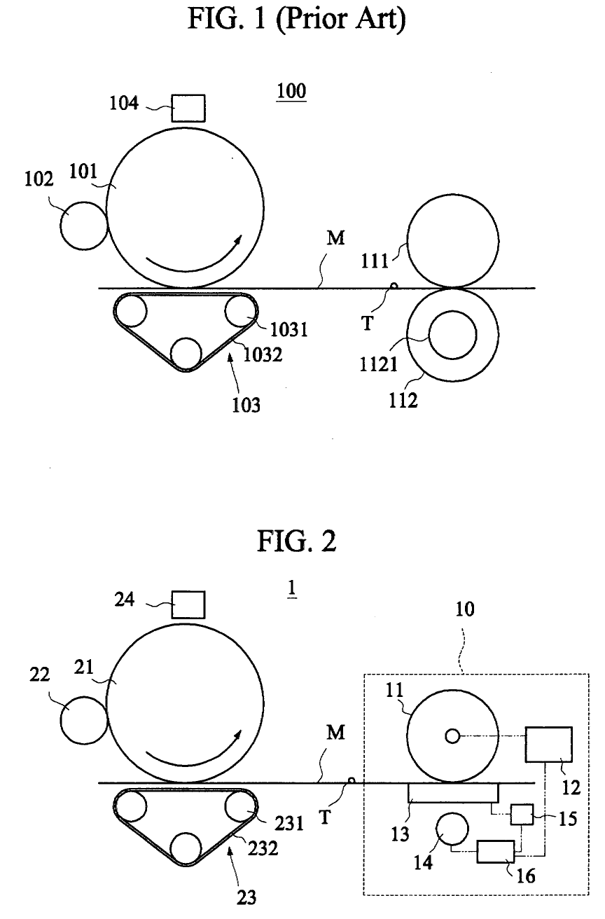

### DETAILED DESCRIPTION OF THE INVENTION

The present invention will be apparent from the following detailed description, which proceeds with reference to the accompanying drawings, wherein the same references relate to the same elements.

FIG. 2 is a partially schematic illustration showing an electrophotographic printing device 1 according to a first embodiment of the invention. Referring to FIG. 2, the electrophotographic printing device 1 of this embodiment includes a fuser assembly 10, a photoconductor drum 21, a toner cartridge 22, a transfer unit 23 and a light source assembly 24. The light source assembly 24, such as a laser light source assembly or a LED light source assembly, outputs an optical signal to the photoconductor drum 21 so that portions (i.e., patterns) with different charges are formed on the photoconductor drum 21. The toners T in the toner cartridge 22 are attracted to the portions on the photoconductor drum 21. Then, the toners T on the photoconductor drum 21 are transferred to a print medium M by the transfer unit 23. The print medium M is usually a sheet or may be any other medium, such as a slide. The transfer unit 23 is mainly composed of a plurality of rollers 231 and a conveyor belt 232. Then, the print medium M is transported across the fuser assembly 10 so that the toners are fused in the high-temperature environment.

The fuser assembly 10 of the electrophotographic printing device according to this embodiment is for fusing the toners T on the print medium M. The fuser assembly 10 includes a fuser roller 11, a driving mechanism 12, a fuser substrate 13 and a heating source 14. The driving mechanism 12 is connected to the fuser roller 11 and drives the fuser roller 11 to rotate and thus the print medium M is moved by the fuser roller 11. The fuser substrate 13 is a high-temperature-resistant opaque substrate or a high-temperature-resistant transparent substrate, and has a friction coefficient smaller than that of the fuser roller 11 to avoid any wear of the fuser roller 11 and the fuser substrate 13 due to the friction there between. For example, the fuser substrate 13 may be a piece of glass. The fuser substrate 13 is stationary and disposed opposite the fuser roller 11, and is in sliding contact with the medium M. The heating source 14 heats the fuser substrate 13 to fuse the toners T on the medium M. The heating source 14 is a radiation heating source for outputting radiating light, and the toners T contact the fuser roller 11. In the high-temperature environment, the fuser roller 11 applies a pressure against the fuser substrate 13 to fuse the toners on the medium M. In one embodiment, the fuser roller 11 may also be a flexible and pliable roller.

In addition, the fuser assembly 10 may further include a temperature sensor 15 and a controller 16. The temperature sensor 15 senses the temperature of the fuser substrate 13 and thus outputs a temperature signal. The controller 16 receives the temperature signal and controls the energy outputted from the heating source 14 according to the temperature signal so as to keep the temperature of the fuser substrate 13 within a predetermined range or even keep the temperature of the fuser substrate 13 constant. The controller 16 also controls the operation of the driving mechanism 12, and the driving mechanism 12 may also drive the photoconductor drum 21, the toner cartridge 22 and the transfer unit 23.

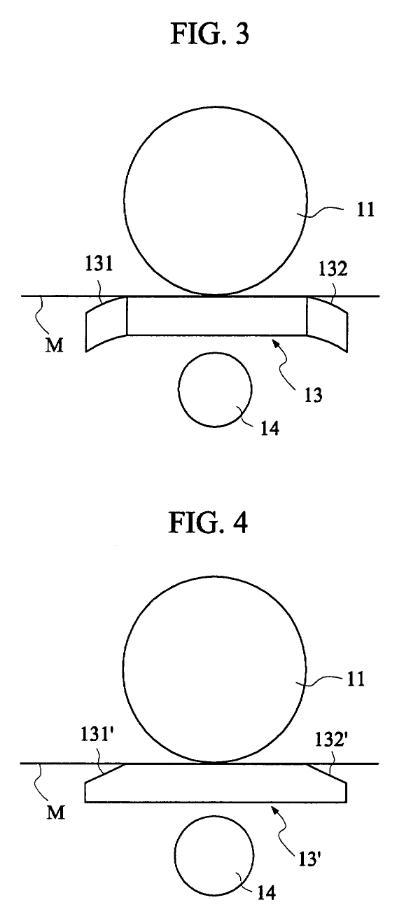

FIG. 3 is a partially schematic illustration showing a fuser assembly according to a second embodiment of the invention. Referring to FIG. 3, the fuser substrate 13 of this embodiment includes a medium guide-in portion 131 for guiding the medium M into a path between the fuser substrate 13 and the fuser roller 11, and a medium guide-out portion 132 for guiding the medium M out of the path between the fuser substrate 13 and the fuser roller 11. In this embodiment, the medium guide-in portion 131 or the medium guide-out portion 132 has an arced surface. It is to be noted that the medium guide-in portion 131 or the medium guide-out portion 132 may also be omitted.

FIG. 4 is a partially schematic illustration showing a fuser assembly according to a third embodiment of the invention. As shown in FIG. 4, this embodiment is similar to the second embodiment except that a medium guide-in portion 131′ or a medium guide-out portion 132′ of a fuser substrate 13′ has an inclined surface.

According to the embodiment of the invention, the fuser assembly has the short warm-up time, the low cost, the low working temperature, the high security, the good constant-temperature keeping effect, the low energy loss and the small occupied space. In addition, because the contact between the fuser roller 11 and the fuser substrate 13 is not the contact between circles, but is the contact between a circle and a plane, the fusing width and area can be increased and the fusing efficiency can be thus enhanced. Because the fusing width and area can be increased, the pressure between the fuser roller 11 and the fuser substrate 13 may be decreased so that the loading of the driving mechanism can be decreased.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A fuser assembly of an electrophotographic printing device, the fuser assembly comprising:
a fuser roller;
a driving mechanism, connected to the fuser roller, for driving the fuser roller to rotate, and thus a medium is moved by the fuser roller;
a fuser substrate, being stationary and disposed opposite the fuser roller, for being in sliding contact with the medium; and
a heating source for heating the fuser substrate so that the fuser substrate fuses toners on the medium.

2. The assembly according to claim 1, wherein the fuser substrate is a high-temperature-resistant substrate.

3. The assembly according to claim 1, wherein the fuser substrate is a transparent substrate.

4. The assembly according to claim 3, wherein the fuser substrate is a piece of glass.

5. The assembly according to claim 1, wherein the fuser substrate has a friction coefficient smaller than that of the fuser roller.

6. The assembly according to claim 1, wherein the heating source is a radiation heating source.

7. The assembly according to claim 1, further comprising:
a temperature sensor for sensing a temperature of the fuser substrate and thus outputting a temperature signal; and
a controller for receiving the temperature signal and controlling energy outputted from the heating source according to the temperature signal to keep the temperature of the fuser substrate within a predetermined range.

8. The assembly according to claim 7, wherein the temperature sensor detects the temperature at a plurality of positions of the fuser substrate.

9. The assembly according to claim 1, wherein the fuser substrate comprises a medium guide-in portion for guiding the medium into a path between the fuser substrate and the fuser roller.

10. The assembly according to claim 9, wherein the medium guide-in portion has an arced surface.

11. The assembly according to claim 9, wherein the medium guide-in portion has an inclined surface.

12. The assembly according to claim 1, wherein the fuser substrate comprises a medium guide-in portion for guiding the medium into a path between the fuser substrate and the fuser roller, and a medium guide-out portion for guiding the medium out of the path between the fuser substrate and the fuser roller.

13. The assembly according to claim 12, wherein one of the medium guide-in portion and the medium guide-out portion has an arced surface.

14. The assembly according to claim 12, wherein one of the medium guide-in portion and the medium guide-out portion has an inclined surface.

15. The assembly according to claim 1, wherein the toners contact the fuser roller.

16. The assembly according to claim 15, wherein the fuser roller applies a pressure against the fuser substrate to fuse the toners on the medium.

17. The assembly according to claim 1, wherein the fuser roller is a flexible roller.
